(19) United States
(12) Patent Application Publication
(10) Pub. No.: US 2026/0124967 A1
(43) Pub. Date: May 7, 2026

(54) VEHICLE SEAT WITH ADJUSTABLE CONSOLE

(71) Applicant: GRAMMER Aktiengesellschaft, Ursensollen (DE)

(72) Inventors: JOHANNES FILLEP, Birgland (DE); FLORIAN SCHANDERL, Schwarzenfeld (DE)

(21) Appl. No.: 19/357,315

(22) Filed: Oct. 14, 2025

(30) Foreign Application Priority Data
Nov. 4, 2024 (DE) 102024132000.1

(51) Int. Cl. B60N 2/08; B60N 2/75

(52) U.S. Cl. CPC B60N 2/0868; B60N 2/773

(57) ABSTRACT

A vehicle seat (1) includes a seat part (2) that can be moved back and forth in a longitudinal direction (X) and having a first console (3a) that can be moved back and forth in the longitudinal direction (X) as well as a vehicle seat base (4). The vehicle seat base (4) has at least one adjustment rail (5) and a first slide (11) attached thereto. The first slide (11) can be moved back and forth in the longitudinal direction (X) by the at least one adjustment rail (5). At least one spacer (14) is arranged on the first slide (11) and at least one spacer (14) firmly connecting the first slide (11) to the seat part (2) is arranged above it. The vehicle seat base (4) has a second slide (12) arranged between the seat part (2) and the first slide (11). The first console (3a) is attached to the second slide (12) and extends predominantly also to the side of the seat part (2). The second slide (12) can slide or roll back and forth on and relative to the first slide (11) in the longitudinal direction (X) and thus the console can be moved relative to the seat part (2).

### CROSS-REFERENCE TO RELATED APPLICATIONS

This application claims priority to German Patent Application 102024132000.1 filed on Nov. 4, 2024, the contents of which are incorporated by reference herein in their entirety.

### TECHNICAL FIELD

The invention relates to a vehicle seat comprising a seat part that can be moved back and forth in a longitudinal direction and comprising a first console that can be moved back and forth in a longitudinal direction and a vehicle seat base, wherein the vehicle seat base has at least one adjustment rail and a first slide attached thereto, wherein the first slide can be moved back and forth in a longitudinal direction by means of the at least one adjustment rail.

### BACKGROUND

Commercial vehicles, such as agricultural machinery, construction machinery, or transport vehicles, usually have consoles extending alongside the seat part, which serve as supports for armrests and operating devices, such as joysticks or control panels. Joysticks in particular must be within reach of the occupant when seated, which is why it is necessary for the console with the joystick to be movable so that its position can be adjusted to the size of the occupant.

In previous vehicle seats, a first adjustment rail was installed on the vehicle seat base and an adapter plate was mounted on top of it. A second adjustment rail was then attached to this adapter plate, and the seat part was mounted on top of that. On the one hand, this meant that when the console was adjusted, the seat part was also adjusted, making it necessary to readjust the distance between the seat part and the pedals or steering wheel. A specific sequence must be followed to adjust the distance. First, the distance between the seat part and the console must be adjusted, and then between the console and the steering wheel, as moving the console also causes the seat part to move. Furthermore, the two adjustment rails can form a long lever arm, which has a negative effect on seat belt tensile tests.

For this reason, and because of possible collisions between the vehicle seat and the cabin wall of the commercial vehicle, the adjustment ranges of the two adjustment rails must be limited.

Consequently, the problem to be solved is to provide a vehicle seat in which an improved adjustment system reduces the space required by the adjustment system, particularly in the vertical direction, and increases comfort and safety.

### SUMMARY

Therefore, a vehicle seat according to the invention is provided, comprising a seat part that can be moved back and forth in a longitudinal direction and comprising a first console that can be moved back and forth in a longitudinal direction, as well as a vehicle seat base, wherein the vehicle seat base has at least one adjustment rail and a first slide attached thereto, wherein the first slide can be moved back and forth in the longitudinal direction by means of the at least one adjustment rail, wherein at least one spacer is arranged on the first slide, which connects the first slide firmly to the seat part arranged above it. The vehicle seat base has a second slide arranged between the seat part and the first slide. The first console is attached to the second slide, which also extends predominantly to the side of the seat part. The second slide can be moved back and forth on the first slide in the longitudinal direction, either sliding or rolling, whereby the second slide can be moved relative to the first slide and thus the console can be moved relative to the seat part.

The longitudinal, width, and height directions describe a Cartesian coordinate system X, Y, Z, which is oriented along the main directions of extension of the vehicle seat. Thus, the seat part extends essentially in the longitudinal and width directions, whereas the height direction extends perpendicular to the longitudinal and width directions.

A console is a component that is arranged on the side of the vehicle seat and serves as a support structure for various other components. In particular, operating devices such as joysticks, control levers, or control buttons are attached to the console, which are used to control the vehicle or attached implements or machines. To ensure easy access, the console can be adjusted both longitudinally and in the height direction. Adjustment along the longitudinal direction in the forward and backward direction serves to adjust the distance between the upper body of an occupant and the console. For smaller occupants, it may be necessary, depending on the length of the occupant's arms, to move the console and any operating device closer to the upper body, i.e., push it back, in order to be able to use the console and any operating device comfortably. For tall occupants, the opposite may be the case due to longer arms, i.e., it may be necessary to move the console far away from the upper body, i.e., forward.

Usually, the vehicle seat has a vehicle seat base that is connected to the body of a vehicle. The vehicle seat base usually has a spring system that cushions relative movement between the vehicle seat and the body in the vertical direction and allows the seat part to be adjusted vertically. The vehicle seat according to the invention now has at least one adjustment rail on which the seat part is arranged so that it can be moved in the longitudinal direction. The adjustment rail itself is preferably fixed and non-movable. A first slide is mounted on the adjustment rail, which can be moved in the longitudinal direction with the aid of the adjustment rail. At least one spacer is also arranged directly on the first slide, to which the seat part is attached. Preferably, the seat part is connected directly to an adjustment rail via the spacers. The spacer creates a space between the first slide and the seat part so that a second slide can be arranged in the space. The second slide can be moved on the first slide so that a console arranged on the second slide can always be adjusted to the seat part.

In a particularly preferred embodiment, at least two front spacers and at least two rear spacers are arranged on the first slide, connecting the first slide to the seat part. The spacers are designed as cylindrical bushings, with the at least two front spacers arranged longitudinally in front of the second slide and the at least two rear spacers arranged longitudinally behind the second slide.

Preferably, the spacers are arranged in a quadrilateral and oriented along the width and length directions. This allows for a balanced load distribution from the seat part to the first slide.

Preferably, the vehicle seat base has two adjustment rails running parallel to each other in the longitudinal direction, which together support the first slide. One front spacer and one rear spacer are arranged directly above each of the two adjustment rails.

According to a particularly preferred embodiment, the second slide is movable between the front and rear spacers, wherein at least one front spacer is a front stop and at least one rear spacer is a rear stop for moving the console in the longitudinal direction.

The stops limit the freedom of movement of the second slide and thus the adjustment of the console attached to the second slide in the forward and backward directions.

Preferably, the second slide can be moved between the stops by more than 100 mm, more preferably by more than 120 mm, and particularly preferably by more than 140 mm.

It is preferred that the first slide can be moved on the adjustment rail by more than 150 mm, more preferably by more than 210 mm, and particularly preferably by more than 230 mm.

According to a particularly preferred embodiment, the first slide comprises a trapezoidal plate element which extends substantially parallel to a plane from the width direction and the length direction, wherein at least two parallel sides of the plate element extend parallel to the length direction.

The plate element can serve as a support or sliding surface for the second slide. In order to ensure uniform sliding properties, the plate element is aligned perpendicular to the force of gravity, which runs in the height direction, and thus parallel to the plane in the longitudinal and width directions.

According to a particularly preferred embodiment, the second slide has at least one first retaining element which at least partially encloses one of the parallel sides of the plate element and by means of which the second slide is attached to the first slide and by means of which the second slide can simultaneously be moved along the first slide in a rolling or sliding manner.

The retaining element thus has two functions. On the one hand, it serves to attach the second slide to the plate element and thus to the first slide, and on the other hand, it allows the second slide to slide or roll on the plate element. According to an alternative embodiment, the retaining element can secure the second slide to the plate element and a sliding and/or rolling element can be provided, with which the second slide can be moved in a sliding or rolling manner on the plate element and thus on the first slide.

For example, the retaining element may be a slot nut that is guided in a groove in the plate element. For a straight movement in the longitudinal direction, the groove is aligned parallel to the longitudinal direction so that the slot nut can be moved in the groove along the longitudinal direction. The slot nut rests on the plate element and slides along the plate element when moved. The ends of the groove can form an additional stop for the movement of the second slide.

According to a particularly preferred embodiment, the second slide has at least one second retaining element that at least partially encloses one of the parallel sides of the plate element, wherein the first retaining element at least partially encloses the opposite side of the plate element and the at least first and at least second retaining elements form a half-form fit with the plate element.

Preferably, the second slide has two retaining elements opposite each other in the width direction, which partially enclose the two opposite parallel sides of the plate element from the outside. The retaining elements may have a U-shaped part. The opposite retaining elements form a half-form fit, since the movement of the second slide is restricted in the width direction and in the height direction by the opposite, partial enclosure of the retaining elements. The half-form fit provided by the retaining elements only allows movement along the longitudinal direction. Movement along the longitudinal direction is also limited by the two stops.

According to a particularly preferred embodiment, a locking device is provided, whereby the second slide can be locked in a position relative to the first slide by the locking device.

According to a particularly preferred embodiment, the locking device comprises a locking element and a latch, wherein the locking element is arranged on the second slide and the latch is arranged on the first slide, or the locking element is arranged on the first slide and the latch is arranged on the second slide, wherein the second slide can be locked relative to the first slide by the latch engaging in the locking element.

A locking device is provided to position the console relative to the seat part. Preferably, the locking device can be locked and released. The locking device can be locked continuously or in steps. The combination of a locking element and a latch is an example of stepwise locking. The locking element can be designed as a rack, for example. If the latch, for example a hook or a second rack, engages in the locking element, the second slide can be locked in the selected position relative to the first slide by a form or force fit. The latch and/or the locking element can be arranged so that they can be moved in the height or width direction, so that the latch and/or the locking element can be moved apart or together to release or lock the locking device. Alternatively, the retaining elements may also be designed as a locking brake. In this case, a lower and/or upper part of the retaining element may be designed as a brake block that can be moved hydraulically, electrically, pneumatically, or mechanically in the height direction. To lock the locking device, the brake block is pressed against the plate element, whereby a force connection is formed, and the second slide is locked relative to the first slide, or the console is locked relative to the seat part. It is also conceivable that the locking device is preloaded by means of a spring, so that a force must be applied to release the locking device.

According to a particularly preferred embodiment, the vehicle seat comprises a second console, wherein the second console also extends predominantly laterally adjacent to the seat part, is arranged opposite the first console, and the second console is attached to the second slide, and both consoles can be moved together and simultaneously.

Advantageously, both consoles are arranged on the second slide, whereby both consoles can be displaced relative to the seat part when the second slide is displaced. Usually, when there are several consoles, they are adjusted evenly, i.e., in the longitudinal direction in the same position or essentially in the same position relative to the seat part. By coupling several consoles to the second slide, they can now be moved simultaneously and parallel to each other and locked together in their positions.

In a particularly preferred embodiment, when the seat part is adjusted forward or backward, the first console maintains its position relative to the seat part, whereas when the first console is adjusted forward or backward, the seat part maintains its position in the longitudinal direction.

Advantageously, the console can be adjusted independently of the seat part and the seat part can be adjusted independently of the vehicle seat base. This means that the occupant is not restricted to a specific sequence for adjusting the positions of the seat part and the console.

According to a particularly preferred embodiment, the first console has an armrest and/or an operating device, and the armrest and/or the operating device are arranged on the upper side of the console.

### BRIEF DESCRIPTION OF THE DRAWINGS

Further advantageous embodiments are apparent from the following description in conjunction with the drawings. Herein are shown:

FIG. 1 a general view of a vehicle seat according to the invention;

FIG. 2 a side view of a vehicle seat according to the invention;

FIG. 3 an isometric view of an arrangement of a first and a second slide according to the invention;

FIG. 4a a side view of an arrangement of a first and a second slide according to the invention;

FIG. 4b a frontal sectional view of an arrangement of a first and a second slide according to the invention;

FIG. 5a a top view of an arrangement of a first slide and a second slide according to the invention in a front maximum position; and

FIG. 5b a top view of an arrangement of a first slide and a second slide according to the invention in a rear maximum position.

For clarity, some reference symbols have been omitted in the figures.

### DETAILED DESCRIPTION

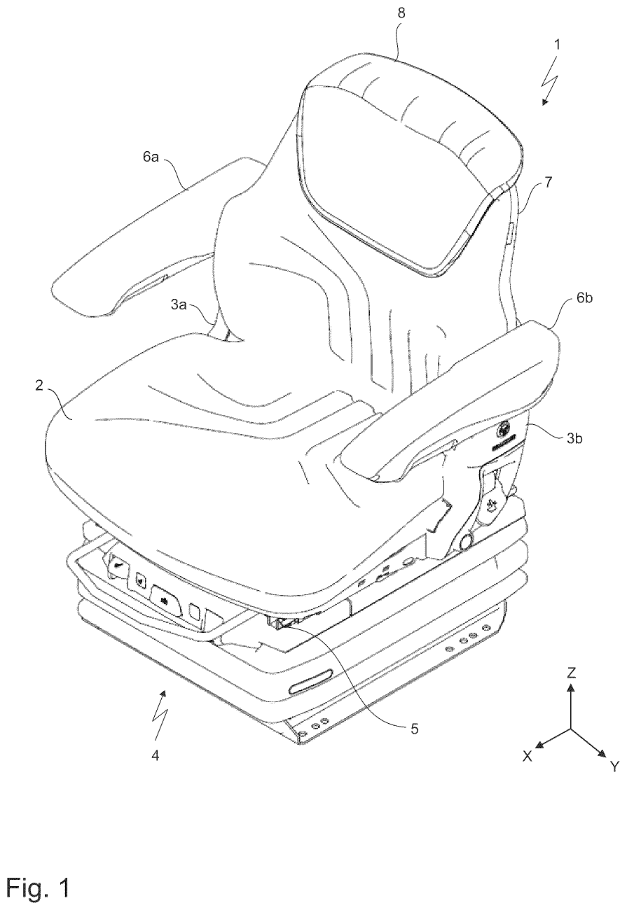

FIG. 1 shows an overall view of a vehicle seat 1 according to the invention. The vehicle seat 1 can be divided into a vehicle seat base 4 and a vehicle seat superstructure arranged above it and supported by it. The vehicle seat superstructure comprises a seat part 2, which extends essentially parallel to the plane from the longitudinal direction X and the width direction Y. A backrest 7 is arranged on the seat part 2, which extends essentially in the height direction Z and in the width direction Y. The backrest 7 is arranged here almost at right angles to the seat part 2, whereby the angle between the seat part 2 and the backrest 7 can be changed by a swivel mechanism. A head section 8 is additionally arranged at the upper end of the backrest 7. To the side of the seat part 2 and to the side of the backrest 7, a first console 3a extends to the right and a second console 3b extends to the left, viewed from the vehicle seat. Both consoles 3a and 3b can be moved in a longitudinal direction relative to the seat part 2 and thus also relative to the backrest 7, which is firmly connected to the seat part 2. For this purpose, the consoles 3a and 3b are not attached to the seat part 2, but to the vehicle seat base 4. The vehicle seat base 4 is screwed to the underside of the vehicle body. In a lower section, the vehicle seat base 4 has a spring device, not visible here, which enables spring movement and height adjustment of the seat structure. Two adjustment rails 5 are arranged above the spring device, running in the longitudinal direction X. Only one adjustment rail 5 is visible here, which is located on the left side of the vehicle seat 1. Another is located on the opposite side in the width direction, on the right side of the vehicle seat. The seat part 2 is attached to the adjustment rails 5 via spacers and can be moved in the longitudinal direction relative to the spring device or relative to the portion of the vehicle seat base 4 arranged below the adjustment rails by means of the adjustment rails. Armrests 6a and 6b are arranged on the upper side of the consoles 3a and 3b shown here.

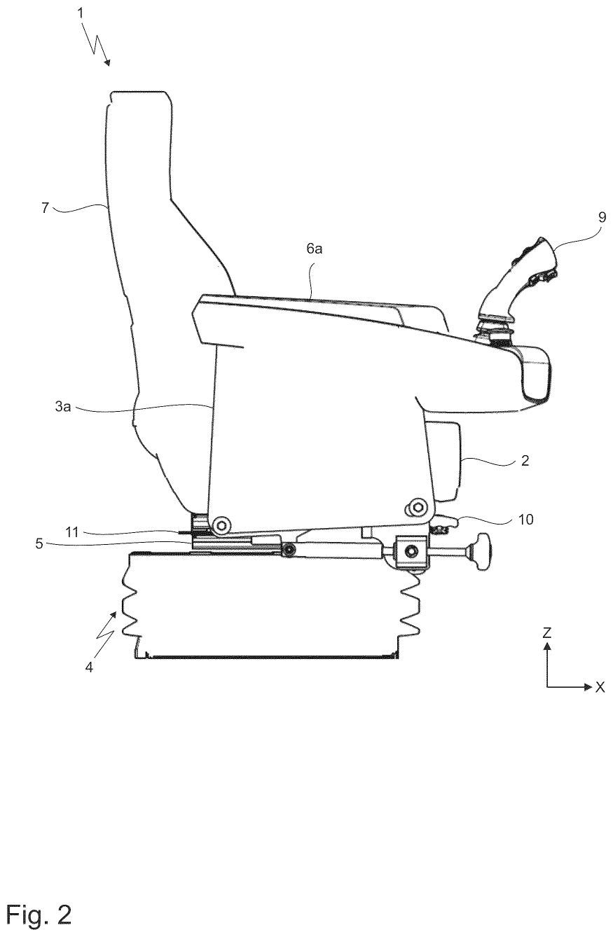

FIG. 2 shows a side view of a vehicle seat 1 according to the invention. A console 3a is shown here, on which, in addition to the armrest 6a, an operating device 9 in the form of a joystick is arranged at a front area. The joystick 9 can be adjusted in relation to the seat part 2 by adjusting the console 3a. One of the two adjustment rails 5 is attached to a lower part of the vehicle seat base 4. A first slide 11 is arranged on the adjustment rail 5, on which the seat part 2 is attached. A locking lever 10 is arranged on the front of the first slide 11, with which a locking device for locking a position of the console 3a in relation to the seat part 2 can be released or locked.

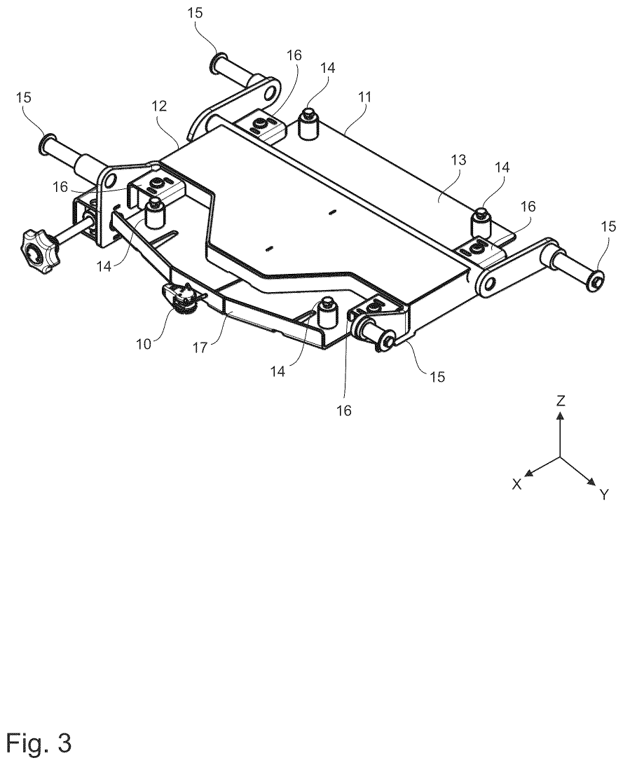

FIG. 3 shows an arrangement of the first slide 11 and the second slide 12. The first slide has an almost rectangular plate element 13, on which cylindrical spacers 14 designed as bushings 14 are arranged in the corner areas. The spacers 14 extend upward from the plate element 13 in the height direction Z. The seat part 2 is arranged on the spacers 14 so that a space is created between the plate element 13 or the first slide 11 and the seat part 2. The spacers 14 can be divided according to their position on the plate element 13 into two front and two rear spacers 14 or, alternatively, into two left and two right spacers 14. The second slide 12 is arranged in the space between the seat part 2 and the first slide 11 and between the front and rear spacers. The second slide 12 is cuboid or box-shaped and wider than the plate element 13, thus protruding laterally beyond the first slide 11. In height, the second slide 12 is smaller than the distance between the plate element 14 and the seat part 2 in the height direction Z. Fastening arms 15, to which the consoles 3a and 3b are fastened, extend in the width direction and are attached laterally to the second slide 12. In addition, the second slide 12 has two front and two rear retaining elements 16. On each side, two retaining elements 16, one front and one rear, engage with the panel element 13 from the outside. The retaining elements 16 partially enclose the edge of the panel element 13. Due to their U-shaped design and the partial enclosing of the plate element 13, the retaining elements form a half-form fit with the plate element, which only allows movement of the second slide in the longitudinal direction X. Movements of the second slide 12 in the width direction Y and height direction Z are restricted or blocked by the half-form fit. In the front area of the first slide 11, the locking lever 10 is arranged centrally on a bar 17 extending in the width direction Y at the front edge of the plate element. This is connected to a latch 19 via a connecting element 18, in this case a Bowden cable 18.

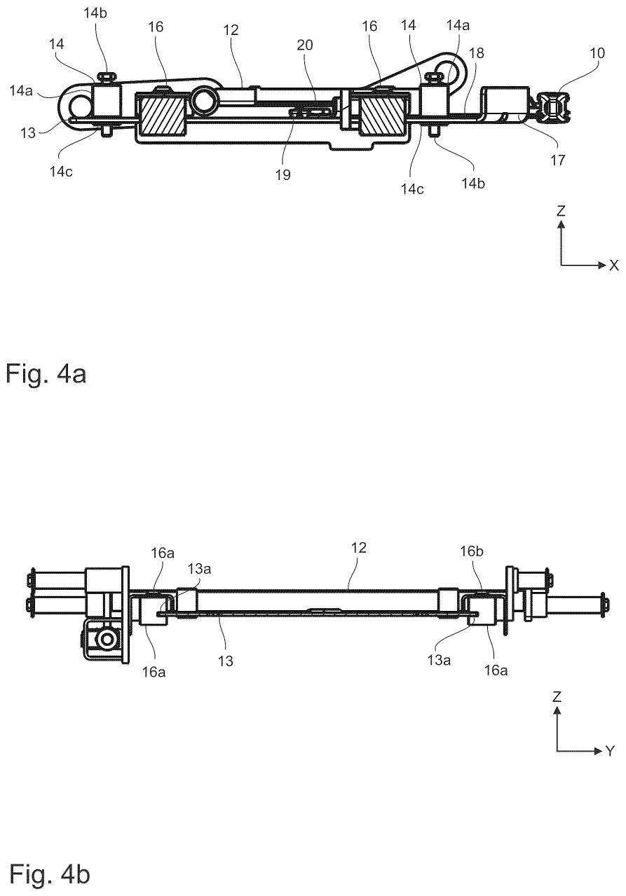

FIG. 4a shows a cross-section through the arrangement of the first and second slides 11 and 12 along the longitudinal direction X. A latch 19 is arranged on the upper side in a central area of the plate element 13. The latch 19 is connected to the locking lever via the Bowden cable 18 and can be locked or released via this. A rack 20 runs along the longitudinal direction X above the latch 19. The rack is attached to the second slide 12 and can engage with the latch 19. The engagement of the latch 19 in the rack 20 creates a form fit that blocks movement of the second slide 12 relative to the first slide 11 in the longitudinal direction. The second slide 12 is shown in FIG. 4a in a middle position, i.e., the second slide 12 is equidistant from the rear and front stops, i.e., it is centered between the bushings 14. The side view with the section through the retaining elements 16 shows that the retaining elements 16 are arranged partly above and partly below the plate element 13. The left spacers 14 are arranged in a front area and a rear area. The spacers 14 have a cylindrical bushing body 14a and a fastening means 14b in the form of a fastening means 14b. The bushing body 14a has a cylindrical recess along its axis of rotation, through which the fastening means 14b is passed. Corresponding holes are drilled into the plate element 13 in the height direction Z at the positions of the spacers 14, with the fastening means 14b passing through the bushing bodies 14a and the holes. The seat part 2 is arranged on the bushing body 14b and connected or screwed directly to an adjustment rail 5 arranged under the plate element 13 by means of the fastening means 14b. Here, two left spacers 14 are screwed to a left adjustment rail 5 and two right spacers 14 are screwed to a right adjustment rail 5. Separating elements 14c in the form of washers, rubber rings, nuts, or similar may be arranged between the seat part 2, the bushing body 14a, the plate element 13, and/or the adjustment rail 5.

FIG. 4b shows a cross-section through the first and second slides 11 and 12 in a front view. A rear retaining element 16 is arranged on each of the right and left sides of the plate element. The first retaining element 16a and are located on the right side, and the second retaining element 16b is located opposite them on the left side. The retaining elements 16 each comprise a slider 16c, which has a recess extending parallel to the plate element 13. The edge area 13a of the plate element 13 is arranged in this recess so that the slider 16c can slide along the edge area 13a of the plate element 13 in the longitudinal direction X. Alternatively, a roller or a roller-slider combination can be used instead of the slider 16c.

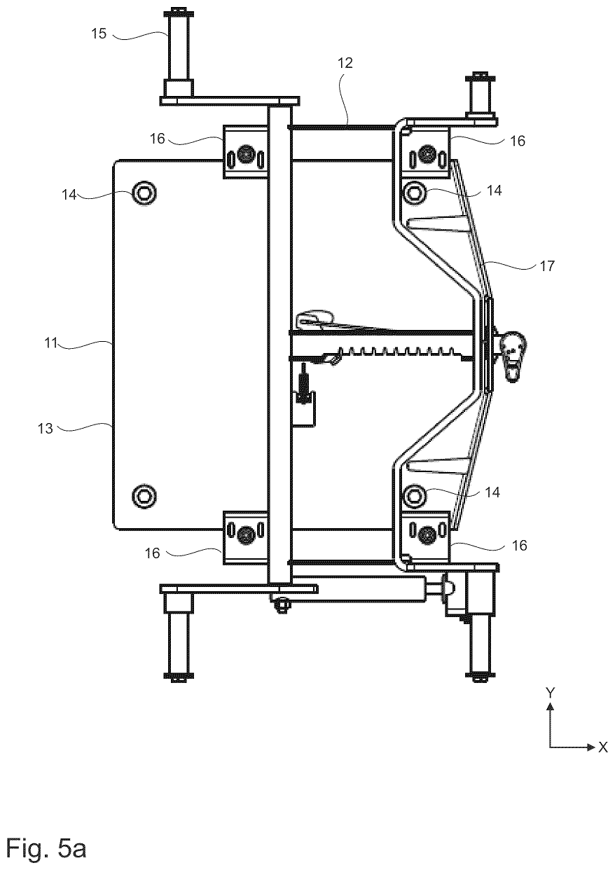

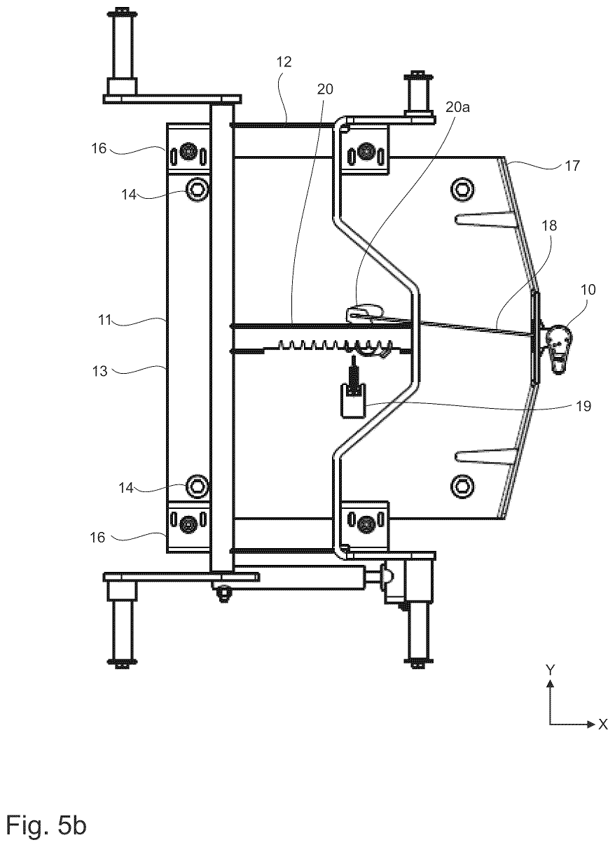

FIG. 5a shows a top view of an arrangement according to the invention of a first slide 11 and a second slide 12 in a maximum forward position. In this position, the second slide 12 is moved forward as far as possible relative to the first slide 11, so that the second slide 12 strikes the spacer 14. Further displacement in the longitudinal direction X is thus limited by the spacers 14. The rectangular second slide 12 has a trapezoidal shape in the center of its front area. The shape increases the extension of the second slide 12 in the longitudinal direction X, so that even with a very long console 3a, where the center of gravity of the console is further away from the first slide in the longitudinal direction X, it rests stably on the first slide without tipping.

FIG. 5b shows a top view of an arrangement of the first slide 11 and second slide 12 according to the invention in a rear maximum position. The second slide 12 is adjusted so far to the rear that it strikes the rear spacers 14. The position of the spacers 14 in the maximum positions is selected such that the retaining elements 16 reach up to the front or rear edge of the plate element 13. The retaining elements 16 do not leave the plate element, i.e., they do not protrude beyond it. The locking lever 10 is attached to the bar 17 as a tiltable lever 10. The Bowden cable 18 is attached to the locking lever 10, whereby it can be released or tensioned by tilting the lever 10. By tensioning or releasing the Bowden cable 18, the position of the rack 20 can be changed via a further lever mechanism 20a. The rack 20 can be moved in the width direction Y and can be moved by a rotary movement of the lever mechanism. The latch 19 is arranged centrally on the first slide 11, slightly offset to the side, with a pin aligned with the rack 20. When the locking lever 10 and thus the Bowden cable is released, the rack 20 is moved toward the latch 19 by a spring force in the lever mechanism 20a, so that the pin of the latch 19 engages in the space between two teeth, in a tooth gap of the rack 20. This results in a positive connection between the latch 19 and the rack 20, which locks the second slide 12 relative to the first slide 11.

### REFERENCE LIST

1 Vehicle seat
2 Seat part
3a First console
3b Second console
4 Vehicle seat base
5 Adjustment rail
6a First armrest
6b Second armrest
7 Backrest
8 Head section
9 Operating device
10 Locking lever
11 First slide
12 Second slide
13 Plate element
13a Edge area
14 Spacer
14a Bushing body
14b Fastening means
14c Separating element
15 Fastening arms
16 Retaining element
16a First retaining element
16b Second retaining element
16c Slider
17 Bar
18 Connecting element
19 Latch
20 Locking element
20a Lever mechanism
X Vehicle seat longitudinal direction
Y Vehicle seat width direction
Z Vehicle seat height direction

1. Vehicle seat (1) comprising a seat part (2) that can be moved back and forth in a longitudinal direction (X) and comprising a first console (3a) that can be moved back and forth in the longitudinal direction (X) and a vehicle seat base (4), wherein the vehicle seat base (4) has at least one adjustment rail (5) and a first slide (11) attached thereto, wherein the first slide (11) can be moved back and forth in the longitudinal direction (X) by means of the at least one adjustment rail (5),
wherein
at least one spacer (14) is arranged on the first slide (11), which spacer firmly connects the first slide (11) to the seat part (2) arranged above it, wherein the vehicle seat base (4) has a second slide (12) which is arranged between the seat part (2) and the first slide (11), wherein the first console (3a) is attached to the second slide (12), which console extends predominantly also to the side of the seat part (2), and wherein the second slide (12) can slide or roll back and forth on the first slide (11) in the longitudinal direction (X), whereby the second slide (12) can be moved relative to the first slide (11) and thus the console can be moved relative to the seat part (2).

2. Vehicle seat (1) according to claim 1,
further comprising
at least two front spacers (14) and at least two rear spacers (14) arranged on the first slide (11), which connect the first slide (11) to the seat part (2), wherein the spacers (14) are designed as cylindrical bushings (14), wherein the at least two front spacers (14) are arranged in the longitudinal direction (X) in front of the second slide (12) and the at least two rear spacers (14) are arranged in the longitudinal direction (X) behind the second slide (12).

3. Vehicle seat (1) according to claim 2,
wherein
the second slide (12) is displaceable between the front and rear spacers (14), wherein at least one front spacer (14) is a front stop and at least one rear spacer

(14) is a rear stop for displacement of the console in the longitudinal direction (X).

4. Vehicle seat (1) according to claim 1,
wherein
the first slide (11) comprises a trapezoidal plate element (13) which extends substantially parallel to a plane defined by the width direction (Y) and the longitudinal direction (X), wherein at least two parallel sides of the plate element (13) extend parallel to the longitudinal direction (X).

5. Vehicle seat (1) according to claim 4,
wherein
the second slide (12) has at least one first retaining element (16a) that at least partially encloses one of the parallel sides of the plate element (13) and by means of which the second slide (12) is attached to the first slide (11) and by means of which the second slide (12) can simultaneously be moved along the first slide (11) by rolling or sliding.

6. Vehicle seat (1) according to claim 5,
wherein
the second slide (12) has at least one second retaining element (16b) which at least partially encloses one of the parallel sides of the plate element (13), wherein the first retaining element (16a) at least partially enclosing the opposite side of the plate element (13), and the at least first and at least second retaining elements (16b) forming a half-form fit with the plate element (13).

7. Vehicle seat (1) according to claim 1,
wherein
a locking device is provided, whereby the second slide (12) can be locked in a position relative to the first slide (11) by the locking device.

8. Vehicle seat (1) according to claim 7, wherein
the locking device comprises a locking element (20) and a latch (19), wherein the locking element (20) is arranged on the second slide (12) and the latch (19) is arranged on the first slide (11), or the locking element (20) is arranged on the first slide (11) and the latch (19) is arranged on the second slide (12), wherein the second slide (12) can be locked relative to the first slide (11) by the latch (19) engaging in the locking element (20).

9. Vehicle seat (1) according to claim 1,
wherein
the vehicle seat (1) comprises a second console (3b), wherein the second console (3b) also extends predominantly laterally adjacent to the seat part (2), is arranged opposite the first console (3a), and the second console (3b) is fastened to the second slide (12), and both consoles (3a, 3b) can be moved together and simultaneously.

10. Vehicle seat (1) according to claim 1,
wherein
when the seat part (2) is adjusted forward or backward, the first console (3a) maintains its position relative to the seat part (2), whereby when the first console is adjusted forward or backward, the seat part (2) maintains its position in the longitudinal direction (X).

11. Vehicle seat (1) according to claim 1,
wherein
operating device (9), and the armrest (6a) and/or the operating device (9) are arranged on the upper side of the console.
